(19) United States
(12) Patent Application Publication
(10) Pub. No.: US 2010/0083915 A1
(43) Pub. Date: Apr. 8, 2010

(54) Electrochemical combustion actuator

(75) Inventors: Gary F. Hawkins, Torrance, CA (US); Thomas J. Curtiss, Redondo Beach, CA (US); Eric W. Fournier, Redondo Beach, CA (US); Michael J. O'Brien, Los Angeles, CA (US)

Correspondence Address: THE AEROSPACE CORPORATION;General Counsel''s Office, 2310 EAST EL SEGUNDO BOULEVARD, MAIL STOP MI/040, EL SEGUNDO, CA, 90245, US

(73) Assignee: The Aerospace Corporation

(21) Appl. No.: 12/287,441

(22) Filed: Oct. 8, 2008

(51) Int. Cl. F02B 43/00

(52) U.S. Cl. 123/3

(57) ABSTRACT

An electromechanical actuator includes a cylinder and piston for driving a load and defining a chamber in which is disposed a buffer gas, such as nitrogen, and a solid or water-based electrolyte, and electrodes for generating hydrogen and oxygen by electrolysis that mixes with the buffer gas serving to control the combustion pressure profile, and into which chamber, above the electrolyte, is inserted an igniter for combusting the hydrogen and oxygen for creating high pressures in the chamber to move the piston and create efficient mechanical work.

### FIELD OF THE INVENTION

The invention relates to the field of internal combustion actuators, engines, thrusters, and motors. More particularly, the present invention relates to internal combustion actuators using electrochemical gas generation, ignition, and combustion.

### BACKGROUND OF THE INVENTION

Many actuators have been developed over the years with various stress and strain characteristics. The best actuators are capable of high strains at high stress levels. Actuators should operate with a high energy density that is measured by stress multiplied by the strain. Very few actuators operate with an energy density greater than 1MJ/m3. The existing actuators that do exceed this 1MJ/m3 value are impractical in many cases for technical reasons. U.S. Pat. No. 6,443,725 teaches an apparatus for generating energy using cyclic combustion of generated hydrogen gas. U.S. Pat. No. 5,671,905 describes previous actuators that essentially work like a hydrogen battery in that actuators create hydrogen gas as the battery is charged to then generate electricity when discharged. Electrochemical actuators create a gas using a reversible electrode but do not provide energetic combustion energy. Using gas to perform work is very inefficient because most of the energy is going into electrochemical energy of the battery rather than mechanical energy indicated by pressure times the volume change, to perform work.

A new class of electrochemical actuators is desirable that is both environmentally safe while providing high-energy efficiencies. Existing actuators of conventional designs are characterized as heavy, slow acting, weak, and energy deficient. These and other disadvantages are solved or reduced using the invention.

### SUMMARY OF THE INVENTION

An object of the invention is to provide a lightweight, powerful, and fast acting electrochemical actuator.

Another object of the invention is to provide an electrochemical combusting actuator using hydrogen and oxygen from water.

Yet another object of the invention is to provide an electrochemical actuator combusting hydrogen and oxygen from water in a chamber containing a buffer gas.

A further object of the invention is to provide an electrochemical actuator combusting hydrogen and oxygen from water in an electrolyte in a chamber containing a buffer gas.

Still another object of the invention is to provide an electrochemical actuator that combusts by glow plug ignition for combusting hydrogen and oxygen from water in an electrolyte in a chamber containing a buffer gas.

Yet a further object of the invention is to provide an electrochemical actuator that combusts by electrical spark for combusting hydrogen and oxygen from water in an electrolyte in a chamber containing a buffer gas.

Still a further object of the invention is to provide an electrochemical actuator that combusts by a laser spark for combusting hydrogen and oxygen from water in an electrolyte comprising water and Nafion in a chamber containing a buffer gas.

The present invention is directed to lightweight, quick acting, powerful, and energy efficient actuators. In a preferred simplest form, the actuator consists of a piston and cylinder encasing a volume defined by a chamber. The chamber is partially filled with a water-based electrolyte. Two electrodes pierce the cylinder wall and protrude into the electrolyte. When an electrical current is passed through the electrolyte, a hydrogen and oxygen gas mixture is generated. The electrolysis builds up pressure in the chamber. When actuation is desired, the hydrogen and oxygen mixture is ignited by the igniter that is preferably a spark plug, glow plug or a focused laser disposed in the chamber. The pressure in the chamber increases by approximately a factor of ten when the mixture detonates in explosion. This explosion causes a large force on the piston for use in actuation. During the actuation, the hydrogen and oxygen recombine to form steam. The steam condenses on the cylinder walls and turns back into water ready for the next actuation cycle.

The actuator achieves a desired energy density by producing high temperatures and pressures through a process of electrolysis followed by combustion. Using gas to perform work is very efficient because most of the energy is mechanical energy to perform work as indicated by pressure times the volume change. A buffer gas is added to increase the peak pressure spike and duration during combustion for improved efficiency in work production. The actuator efficiently converts electrical energy into mechanical energy, reaches high stress levels using low current levels, and rapidly actuates. These and other advantages will become more apparent from the following detailed description of the preferred embodiment.

### BRIEF DESCRIPTION OF THE DRAWINGS

FIG. 1 is a diagram of an electrochemical combustion actuator.

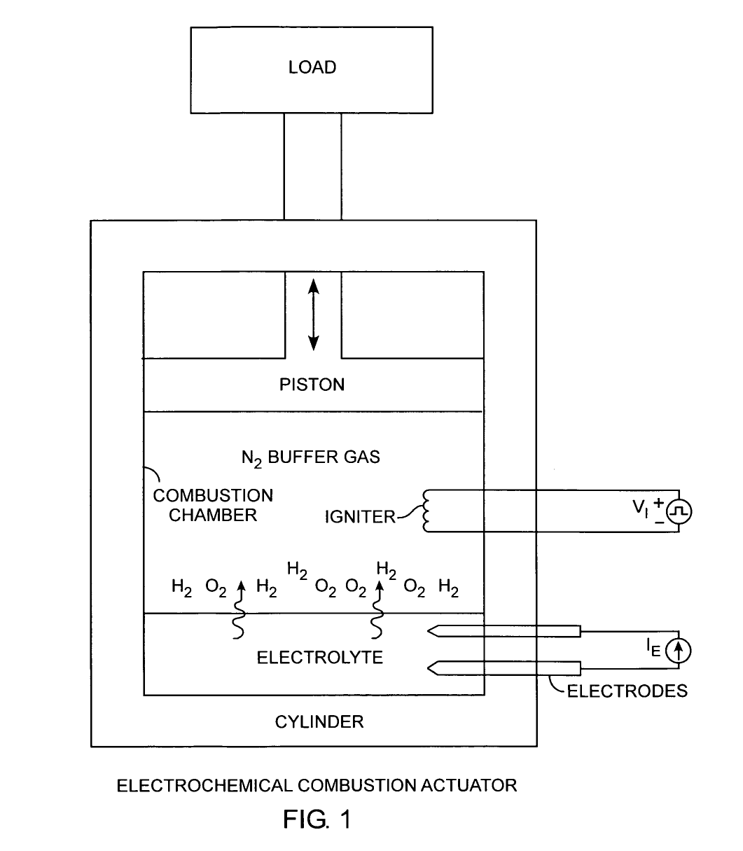

FIG. 2 is a combustion pressure profile plot for various buffer gases.

### DETAILED DESCRIPTION OF THE PREFERRED EMBODIMENTS

An embodiment of the invention is described with reference to the figures using reference designations as shown in the figures. Referring to the Figures, an electrochemical combustion actuator has a cylinder defining a combustion chamber, in which is disposed an electrolyte and a piston. The piston and cylinder encase the chamber volume. The piston is attached to and drives a load.

Two electrodes penetrate the cylinder into the chamber and into the electrolyte. A simple electrode design is merely two closely spaced platinum wires or a platinum-plated electrolyte membrane. The two electrodes pierce the cylinder wall and protrude into the electrolyte for activating the electrolyte. An electrical current from an electrolytic current source I_{E} is passed through the electrodes and through the electrolyte to generate hydrogen gas H₂ and oxygen gas O₂. The chamber volume expands by moving the piston in response to internal gas pressure. Preferably, the cylinder uses sealed bellows. The chamber contains water and a buffer gas. The preferred electrolyte is water. The two electrodes pass through the cylinder wall below the water level and into the electrolyte. The actuator and piston design can provide for relatively long stroke energy production.

The electrolyte is water based. The electrolyte can be a simple salt solution. The electrolyte can be a basic or acidic solution. The electrolyte can comprise solid and semisolid disposed in water or a water solution. An electrolyte is any substance containing free ions that behaves as an electrically conductive medium. Because electrolytes generally comprise ions in solution, electrolytes are also known as ionic solutions, but molten electrolytes and solid electrolytes containing water may also be used. For example, Nafion is a sulfonated tetrafluorethylene copolymer sold under the trademark Nafion of the DuPont Corporation. Nafion is a class of synthetic polymers with ionic properties, which are called ionomers. Nafion's unique ionic properties are a result of incorporating perfluorovinyl ether groups terminated with sulfonate groups onto a tetrafluorethylene backbone. Nafion can be used as a proton conductor of a proton exchange membrane having good thermal and mechanical stability. The chemical basis for the conductive properties of Nafion is derived from protons on sulfonic acid that hop for one acid site to another. Pores in the membrane allow for movement of cations, but the membrane does not conduct anions or electrons. Nafion can be manufactured with various cationic conductivities. A proton exchange membrane is disposed between the two electrodes and submerged in pure water. The electrolyte may then comprise pure water and a proton exchange membrane made of Nafion. The water never needs to be replenished. When an electric current is passed through the Nafion, the surrounding water undergoes an electrolysis process in which the hydrogen and oxygen atoms are debonded and bubble to the surface of the water as gases. The electrolyte comprising the membrane is disposed in the cylinder. The hydrogen and oxygen gases are contained within the cylinder and ignited by the igniter, which then combusts the hydrogen in the cylinder using the generated oxygen as the oxidizer, resulting in a return of water to the electrolyte.

An igniter is also disposed in the cylinder. The igniter is used to ignite the mixture of hydrogen and oxygen. The igniter passes through the cylinder wall above the electrolyte level. When current is passed through the electrolyte, hydrogen and oxygen gas is generated and fills the chamber. This electrolysis builds up pressure in the chamber. When actuation is desired, the hydrogen and oxygen mixture is ignited by the igniter. By way of example, the igniter can be a resistive coil driven by an ignition voltage source V_{I}. Alternatively, the igniter can be two electrodes separated by a spark gap. Alternatively, the igniter can be a focused laser. That is, the igniter is preferably a spark plug, a focused laser, or a glow plug disposed in the chamber. Preferably, the cylinder further initially includes a buffer gas, such as nitrogen gas N₂. The chamber is partially filled with a water-based electrolyte and the buffer gas. The electrolyte can be mere water. When a voltage of greater than 1.23V is applied to the electrodes, the water decomposes into hydrogen and oxygen gas through electrolysis. Hydrogen and oxygen bubble up through the water and mix with the buffer gas.

When ignited, the pressure in the chamber increases by approximately a factor of ten as the mixture combusts. This increase in pressure rapidly reaches an impulse maximum pressure providing a total amount of energy pursuant to a combustion pressure profile for the buffer gas. The higher the impulse maximum pressure, the more energy provided from combustion. The combustion causes a large force upon the piston for use in actuation. The maximum pressure and total energy provided can be controlled in part by the type buffer gas used and partial pressure of the buffer gas. During the actuation, the hydrogen and oxygen recombine to form steam. The steam condenses on the cylinder walls and turns back into water ready for the next actuation cycle. The actuator can be repetitively ignited for providing repeating pulsed energy.

When the pressure in the chamber reaches the desired level, the igniter ignites the hydrogen and oxygen mixture causing them to recombine creating steam. The resulting steam and hot buffer gas cause the pressure inside the chamber to abruptly increase. The pressure increase pushes the piston causing mechanical work. The hydrogen and oxygen gases combust upon ignition. The buffer gas slows down the reaction and retains heat in the chamber. This decreases the rate of the pressure drop that results from the steam condensing on the walls and turning back into water to rapidly. In many cases, increasing the time of the pressure pulse allows the mechanical work to be tuned to a predetermined force profile of the actuator so that more mechanical work can be performed.

In electrolysis, chemical reaction is caused by passing an electric current through an electrolyte solution between two electrodes to dissociate a substance. The electrolyte solution contains the substance to be dissociated and a readily ionized species, such as a salt, to transfer charge between the electrodes. In the electrolysis of water, reduction occurs at the electrode where a negative charge enters the solution at the cathode producing hydrogen gas. Oxidation occurs at the positive electrode at the anode producing oxygen gas. The half reaction standard electrode potential characterizes the reactions. The standard potential E^{O} uses the convention that the standard potential for hydrogen gas is defined as 0V, with all species having an activity of one, all solutions are one Molar, all gases are at a partial pressure of one atmosphere, and the temperature is 25° C. The half reaction standard electrode potentials for the electrolysis of water to produce hydrogen and oxygen gases are 4H⁺(aq)+4e⁻→2H₂ at 0V and 2H₂O(aq)→O₂+4H⁺(aq)+4e⁻ at −1.229V. Combining the half reactions gives the standard cell potential for 2H₂O→2H₂(g)+O₂(g) at E^{O}=−1.229 V. The reaction will not proceed unless the cell is above the standard cell potential. Above this voltage, the rate increases with increasing voltage. At the standard cell potential, the reaction proceeds very slowly. The reaction rate increases with increasing voltage. For example, the electrolysis reactions can provide four moles of electron transfer, yielding two moles of hydrogen gas and one mole of oxygen gas. This stoichiometry and the ideal gas law can be used to determine the required charge for pressurizing a given volume. For example, the charge required to pressurize a 1 cc volume to 100 psi, with 0.00028 moles of H₂+O₂ requiring 0.00037 moles of electrons, is 36.0 coulombs or 0.010 Amp-hour.

A combustible hydrogen and oxygen gas mixture, such as that produced by electrolysis of water, is ignited to provide a high-pressure pulse that can drive a mechanical actuator. The combustion process rapidly releases heat, causing a rapid increase in the gas temperature. When the volume is constrained, the temperature increase results in a pressure increase in accordance with the ideal gas law. In an ideal sealed system, which does no work, the pressure increase persists until the temperature declines. In real systems, the temperature and pressure decline as heat is lost to the surroundings. Pressure is also lost as steam condenses to liquid water.

Resistive losses occur as a result of the energy required to move ions between the electrodes. Resistive losses can be overcome by increasing the voltage. This increases the power requirement so efficient designs have closely-spaced large surface area electrodes to minimize the resistive loss. The electrode material must carry current throughout the process, withstand contact with the electrolysis products, and not compete with the desired chemical reaction. Platinum, due to its chemical inertness and resistance to oxidation is a common choice for electrode material. Platinum wires immersed in a neutral ionic aqueous solution can be used. Although the efficiency could be improved by increasing the surface area and reducing the spacing between electrodes, other approaches used in industry are more efficient. Other approaches include the use of a polymer exchange membrane as the electrolyte. The electrodes are plated or pressed onto the polymer membrane. The membrane can be on the order of 0.1 mm thick, which reduces resistive losses between the electrodes. This approach does not require the use of acidic and caustic materials. The electrode assemblies can be stacked and fit into a compact package. Nickel electrodes could be used in caustic solutions. The nickel electrode is more power efficient but requires the handling of a caustic potassium hydroxide solution.

The presence of an unreactive buffer gas, such as nitrogen or argon, slows the diffusion of hot combustion products and so slows the rate of heat loss to the surrounding walls. Consequently, when a buffer gas is present, the system remains longer at elevated temperature and pressure. Gas diffusion rates are inversely proportional to gas density so the pressure effect is increased by increasing buffer gas pressure. However, when present in sufficient concentrations, the buffer gas, which does not contribute to combustion, acts as a combustion suppressant. When the combustion process is sufficiently suppressed, less heat is produced and the peak pressure is lower. Larger molecules, such as carbon dioxide and sulfur hexafluoride, have several internal modes, providing high heat capacities acting as suppressants at lower concentrations than noble gasses. The presence of a buffer gas at concentrations that do not strongly suppress combustion results in higher peak pressures. The presence of the buffer gas reduces heat loss at early times so higher temperatures and pressures are obtained.

The effect of the buffer gas depends on its chemical species. Nobel gases such as helium and argon have no molecular bonds, so all of the energy goes into translation, which increases the pressure. Argon has a higher mass than helium so diffusion of the hot combustion products will be slower and the temperature and pressure will remain high longer. Molecules such as nitrogen, carbon dioxide, and sulfur hexafluoride have higher masses than helium, but have internal modes, which do not result in pressure increase, and some of the energy goes into the modes. The electrode design can be optimized for gas generation. Doubling the size of the electrodes doubled the gas generation rate.

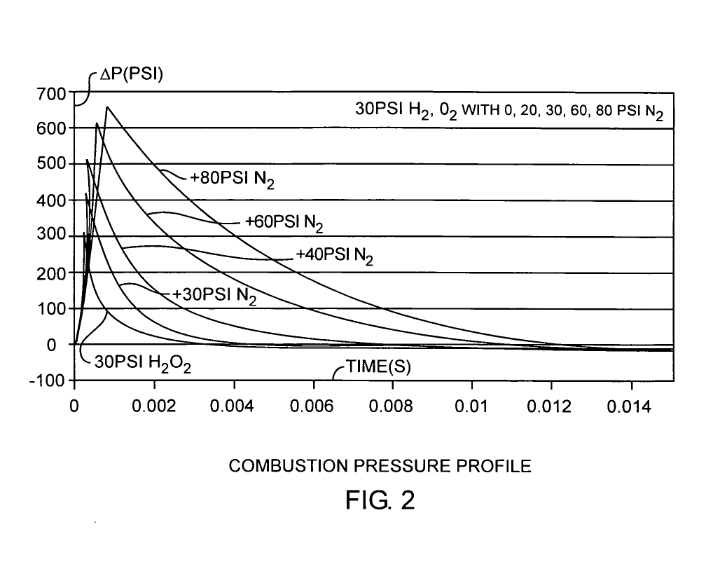

The pressure change measured for stoichiometric 30 psi H₂:O₂ recombination pressurized with various buffer gases is in the 400-1000 psi range. Pressure over time data shows buffer gas conditions can be varied to give useful control of pressure transients peak pressures and extend the time duration from sub-millisecond to the ten-millisecond range. FIG. 2 shows the pressure response to the pressure change at ignition of 30 psi stoichiometric H₂+O₂, that is, two parts hydrogen and one part oxygen, for mixtures with various amounts of added nitrogen. Pressure at 0 volts corresponds to the total H₂+O₂+N₂ gas pressure before ignition, which is 30 psig, 40 psig, 60 psig or 80 psig depending on the amount of nitrogen added for approximately 14 milliseconds after ignition. The 0.0 time is the triggering point for data acquisition and corresponds to a pressure rise of 15 psi. Ignition occurs slightly before the 0 time. Ignition is by a heated platinum wire. The pressure increases can be in the 400-900 psi range. The pressure eventually falls below the initial value because the combustion 2H₂+O₂→2H₂O results in fewer moles of gas and the water product condenses on the walls.

Various buffer gases can be used. The diffusion through helium is much faster than through argon. The result is that the temperature and pressure drop more rapidly than in argon bath gas. Sulfur hexafluoride SF6 has many internal modes and a high heat capacity. When added in sufficient quantities, SF6 acts as a combustion suppressant and pressures are lower than for undiluted combustion. Higher pressures and longer periods are possible with argon than with nitrogen bath gas and this has been confirmed in experiments. Helium and sulfur hexafluoride have also been tested as bath gases. Sulfur hexafluoride has a very high heat capacity, which at higher pressures results in a marked delay in the pressure peak and a reduction in the peak pressure. Carbon dioxide could be used as the buffer gas having high heat capacity.

The invention is directed to an electrochemical combustion actuator that is high power, high energy density, and lightweight. The actuator receives electrical energy that is preferably supplied by when actuator is idle in between piston strokes. The actuator can be charged by generating the hydrogen and oxygen at a slow rate and then, at a later time, actuated quickly upon combustion. Because the force, not the strain, is controlled by this actuator, the actuator responds like a solenoid. The actuator can be used to replace solenoids. Various electrolytes, buffer gases, igniters, electrodes, pistons, and chambers can be used in the actuator to provide electromechanical energy. Those skilled in the art can make enhancements, improvements, and modifications to the invention, and these enhancements, improvements, and modifications may nonetheless fall within the spirit and scope of the following claims.

What is claimed is:

1. An actuator for providing mechanical work, the actuator comprising,
a cylinder for encapsulating and defining a chamber,
an electrolyte disposed in the chamber,
electrodes extending into the electrolyte, the electrolyte containing water, the electrodes for passing a current for electrolytically generating oxygen and hydrogen from the electrolyte,
an igniter extending into the chamber for igniting the oxygen and hydrogen in the chamber producing increased gas pressure in the chamber, and
a piston disposed in the chamber being moved under the increase gas pressure for providing the mechanical work.

2. The actuator of claim 1 further comprising,
a buffer gas disposed in the chamber.

3. The actuator of claim 1 further comprising,
a buffer gas disposed in the chamber for controlling the increased gas pressure over time after ignition.

4. The actuator of claim 1 further comprising,
a buffer gas disposed in the chamber for controlling the increased gas pressure over time after ignition, the buffer gas selected from the group consisting of nitrogen, helium, argon, sulfur hexafluoride, and carbon dioxide.

5. The actuator of claim 1 further comprising,
a buffer gas disposed in the chamber for controlling the increased gas pressure over time after ignition, the buffer gas being a noble gas.

6. The actuator of claim 1 wherein,
the igniter is selected from the group consisting of spark plugs, coils, and lasers.

7. The actuator of claim 1 wherein,
the electrodes are platinum electrodes.

8. The actuator of claim 1 wherein,
the electrodes are selected from the group consisting of wires and meshes.

9. The actuator of claim 1 wherein,
the electrolyte is water.

10. The actuator of claim 1 wherein,
the electrolyte comprises water and Nafion.

11. The actuator of claim 1 wherein,
the electrolyte comprises water and a proton exchange membrane.

12. The actuator of claim 1 wherein,
the electrolyte comprises water and proton exchange membrane, the proton exchange membrane disposed between the electrodes.

13. An actuator for providing mechanical work, the actuator comprising,
a cylinder for defining a chamber,
an electrolyte disposed in the chamber,
a buffer gas disposed in the chamber,
electrodes extending into the electrolyte, the electrolyte comprising water, the electrodes for passing a current for electrolytically generating oxygen and hydrogen from the electrolyte,
an igniter extending into the chamber for igniting the oxygen and hydrogen in the chamber producing increased gas pressure in the chamber, and
a piston disposed in the chamber being moved under the increase gas pressure for providing the mechanical work, the buffer gas controlling the increased gas pressure over time after ignition.

14. The actuator of claim 13 wherein,
the buffer gas is nitrogen, and
the electrodes comprise platinum.

15. The actuator of claim 13 wherein,
the piston moves a load after ignition.

16. The actuator of claim 13 wherein,
the electrolyte comprises water and a proton exchange membrane.

17. The actuator of claim 13 wherein,
the electrolyte comprises water and a proton exchange membrane, and
the buffer gas is nitrogen.

18. The actuator of claim 13 wherein,
the electrolyte comprises water and Nafion,
the buffer gas is nitrogen, and
the electrodes comprise platinum.
